(19) United States
(12) Patent Application Publication
(10) Pub. No.: US 2026/0287351 A1
(43) Pub. Date: Sep. 24, 2026

(54) Rotating Laser having a Contact Element

(71) Applicant: Robert Bosch GmbH, Stuttgart (DE)

(72) Inventor: Tobias Roehm, Wildberg-Sulz (DE)

(21) Appl. No.: 19/567,935

(22) Filed: Mar. 16, 2026

(30) Foreign Application Priority Data
Mar. 20, 2025 (DE) 10 2025 110 737.8

(51) Int. Cl. G01C 15/00; G01C 9/02

(52) U.S. Cl. CPC G01C 15/004; G01C 9/02

(57) ABSTRACT

A rotating laser has a housing, in which a housing-fixed base plate is arranged at a predefined distance from a carrier plate. A laser assembly is assigned to the carrier plate. An overload protection device for protecting the laser assembly in the event of an overload is provided.

This application claims priority under 35 U.S.C. § 119 to patent application no. DE 102025 110 737.8, filed on Mar. 20, 2025 in Germany, the disclosure of which is incorporated herein by reference in its entirety.

### BACKGROUND

The present disclosure relates to a rotating laser comprising a housing, in which a housing-fixed base plate is arranged at a predefined distance from a carrier plate, wherein the carrier plate is assigned to a laser assembly.

From the prior art, such a rotating laser comprising a housing is known, in which a housing-fixed base plate is arranged at a predefined distance from a carrier plate. A laser assembly is assigned to the carrier plate.

### SUMMARY

The disclosure relates to a rotating laser comprising a housing in which a housing-fixed base plate is arranged at a predefined distance from a carrier plate, wherein a laser assembly is assigned to the carrier plate. An overload protection device is provided for protecting the laser assembly in the event of an overload.

The disclosure thus enables provision of a rotating laser in which undesired destruction of the rotating laser may be prevented by the overload protection device.

Preferably, the laser assembly comprises a laser unit for generating a laser beam, a drive unit for rotating the laser beam, and a leveling unit for setting an inclination angle of the carrier plate relative to the housing-fixed base plate, wherein the leveling unit comprises at least one inclination sensor and at least one inclination adjustment unit and/or comprises a control board assigned to an electronics unit.

Thus, a suitable laser assembly may be provided in a simple manner.

Preferably, the laser assembly is arranged on the carrier plate.

Thus, safe and reliable arrangement of the laser assembly in the rotating laser may be enabled.

Preferably, a housing is assigned to the carrier plate, in which at least the at least one inclination sensor of the leveling unit and/or the drive unit is arranged.

Thus, a protected arrangement of the at least one inclination sensor of the leveling unit and/or of the drive unit may be easily and simply provided.

Preferably, at an outer circumference of the carrier plate, at least one damping protective element is arranged, which is assigned to the overload protection device.

Thus, the laser assembly assigned to the carrier plate may be protected safely and reliably.

Preferably, the at least one damping protective element comprises damping foam.

Thus, a suitable damping protective element may be provided easily and simply.

Preferably, at an inner circumference of the housing, at least one damping protective element is arranged, which is assigned to the overload protection device.

Thus, an alternative arrangement of the at least one damping protective element may be enabled.

Preferably, an adhesive is assigned to the at least one damping protective element for forming an adhesive bond with the carrier plate and/or the housing.

Thus, a secure and reliable arrangement of the at least one damping protective element on the carrier plate and/or the housing may be achieved.

Preferably, the overload protection device comprises a protective element assigned to the at least one inclination adjustment unit.

Thus, protection of the inclination adjustment unit in the event of an overload may be achieved easily and reliably.

Preferably, the inclination adjustment unit comprises an inclination adjustment unit housing in which at least one motor having a drive spindle for displacing a plunger along a longitudinal extent of the drive spindle is arranged, wherein the plunger bears against the housing-fixed base plate, and displacing the plunger along the longitudinal extent sets a predefined inclination angle of the carrier plate relative to the housing-fixed base plate, and wherein the protective element configured to be a spring element is arranged within the inclination adjustment unit housing. Alternatively, the protective element is arranged in an interior space of the plunger coaxially to the drive spindle.

Thus, a suitable arrangement of the protective element may be provided in a simple manner.

Preferably, the protective element is arranged on the drive side and/or on the output side on the motor.

Thus, a suitable arrangement of the protective element may be easily and simply achieved.

Preferably, an end-stop unit having at least one contact element is provided, which is configured to deactivate the inclination adjustment unit upon reaching a maximum possible inclination angle, wherein the at least one contact element is electrically conductive, and wherein the at least one contact element is assigned to the overload protection device.

Thus, destruction of the laser assembly at a maximally possible inclination angle may be safely and reliably prevented.

Preferably, the at least one contact element is elastically deformable in the event of an overload for protecting the laser assembly.

Thus, a suitable contact element may be provided in a simple manner.

Preferably, upon reaching a maximum possible inclination angle, the at least one contact element contacts a contact surface arranged on the housing-fixed base plate and assigned to a control board and thus deactivates the motor assigned to the inclination adjustment unit.

Thus, reliable safe operation of the laser assembly may be enabled.

### BRIEF DESCRIPTION OF THE DRAWINGS

The disclosure is explained in greater detail in the following description on the basis of exemplary embodiments illustrated in the drawings. It shows:

FIG. 1 a perspective view of a rotating laser according to the disclosure,

FIG. 2 a perspective view of a laser assembly assigned to the rotating laser of FIG. 1, having a base plate,

FIG. 3 a perspective view of the laser assembly of FIG. 2,

FIG. 4 a sectional view of the rotating laser of FIG. 1 having the laser assembly of FIG. 2 and FIG. 3 at a first inclination angle,

FIG. 5 a sectional view of the rotating laser of FIG. 1 having the laser assembly of FIG. 2 and FIG. 3 at a further inclination angle,

FIG. 6 an exploded view of an inclination adjustment unit of the rotating laser of FIG. 1 and FIG. 4 and FIG. 5,

FIG. 7 a sectional view of the inclination adjustment unit of FIG. 6 in a first position,

FIG. 8 a sectional view of the inclination adjustment unit of FIG. 6 in a further position,

FIG. 9 a perspective view of a guide part assigned to the inclination adjustment unit of FIG. 6 and FIG. 7,

FIG. 10 a sectional view of the inclination adjustment unit of FIG. 6 and FIG. 7 for illustrating a bayonet connection,

FIG. 11 a sectional view of an alternative inclination adjustment unit in a first position,

FIG. 12 a sectional view of an alternative inclination adjustment unit of the rotating laser of FIG. 1 and FIG. 4 and FIG. 5, in a further position,

FIG. 13 a sectional view of an arrangement assigned to the inclination adjustment unit of FIG. 11, of a motor of the inclination adjustment unit,

FIG. 14 an exploded view of a further inclination adjustment unit of the rotating laser of FIG. 1 and FIG. 4 and FIG. 5,

FIG. 15 a sectional view of the inclination adjustment unit of FIG. 13 in a first position,

FIG. 16 a sectional view of the inclination adjustment unit of FIG. 13 in a second position,

FIG. 17 a sectional view of the inclination adjustment unit of FIG. 13 in a further position,

FIG. 18 a perspective view of the base plate of FIG. 2,

FIG. 19 a plan view of the laser assembly of FIG. 2 and FIG. 3,

FIG. 20 a sectional view of the laser assembly of FIG. 2, FIG. 3, FIG. 19 having the base plate of FIG. 2 and FIG. 18, and

FIG. 21 a perspective view of a contact element of the laser assembly of FIG. 2, FIG. 3, FIG. 19, and FIG. 20.

### DETAILED DESCRIPTION

In the figures, elements having identical or comparable function are provided with identical reference signs and are described in more detail only once.

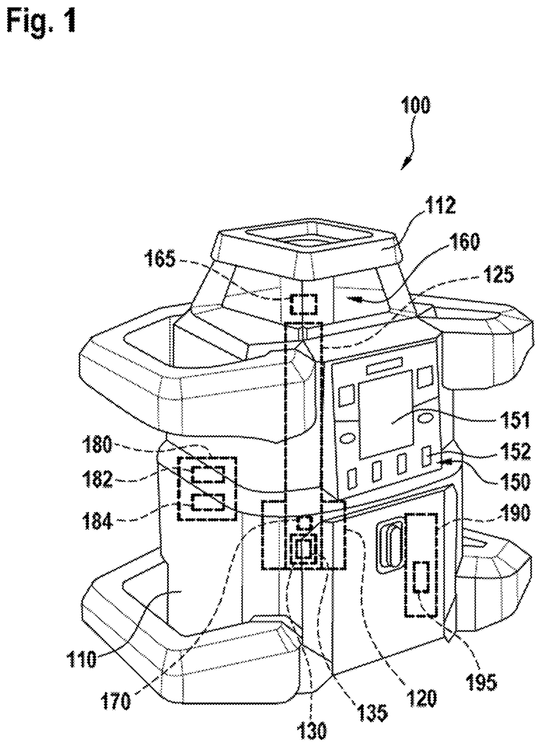

FIG. 1 shows an exemplary rotating laser 100 having a housing 110 in which a laser unit 130 having a laser diode 135 for generating a laser beam is arranged. A “rotating laser,” in the context of the present disclosure, may also be understood as a construction laser or a leveling laser. Furthermore, a drive unit 120 for rotatably driving a spindle 125 is exemplarily arranged in the housing 110. Preferably, the drive unit 120 is configured to be an electric motor.

The laser unit 130 is arranged on the spindle 125 such that, by a rotation of the spindle 125, the laser beam generated by the laser unit 130 rotates in an assigned plane. For this purpose, a rotating head 160 having a beam deflector 165 is preferably assigned to the spindle 125. The beam deflector 165 is preferably configured to deflect the laser beam, whereby the laser beam projects the assigned plane. Depending on the configuration of the rotary laser 100, the projected plane may extend horizontally, vertically, or, for example, with a defined inclination angle relative to the ground surface.

Furthermore, an electronics unit 190 having a control and monitoring device 195 is preferably arranged in the housing 110. The control and monitoring device 195 is preferably configured to control a laser power of the laser unit 130 as a function of a respective operating mode. Here, a rotational speed of the spindle 125 of the drive unit 120 is controlled or regulated. Preferably, a determination unit 170 is assigned to the spindle 125 for this purpose.

By way of example, a cage 112 assigned to the rotating head 160 is assigned to the housing 110 for protecting against an impact of the rotating head 160.

The electronics unit 190 is assigned to an operating unit 150 having a display 151 and an input unit 152. The operating unit 150 is preferably connected to the electronics unit 190, in particular, to the control and monitoring device 195, in terms of control or regulation. The input unit 152 preferably comprises at least one keypad. Alternatively, the input unit 152 may comprise a rotating control, a touchscreen, a slider, a remote control, or the like. Via the input unit 152, a user may input, for example, a rotational speed for the spindle 125. Alternatively, the rotational speed of the laser unit 130 may be automatically controllable in at least one operating mode.

Preferably, the rotating laser (100) comprises at least one inclination sensor (184), which is configured to determine an inclination of the rotating head (160), in particular, of the beam deflector (165), and/or of the laser unit (130) relative to a predefined direction, preferably a horizontal direction, or relative to the vertical. Furthermore, the rotating laser 100 preferably comprises at least one inclination adjustment unit 182, which is configured to align the rotating head 160, in particular, the beam deflector 165, and/or the laser unit 130 relative to the vertical as a function of a position determined by way of the at least one inclination sensor 184, preferably an inclination of the laser unit 130 and/or of the rotating head 160. The at least one inclination sensor 184 and the at least one inclination adjustment unit 182 form a leveling unit 180.

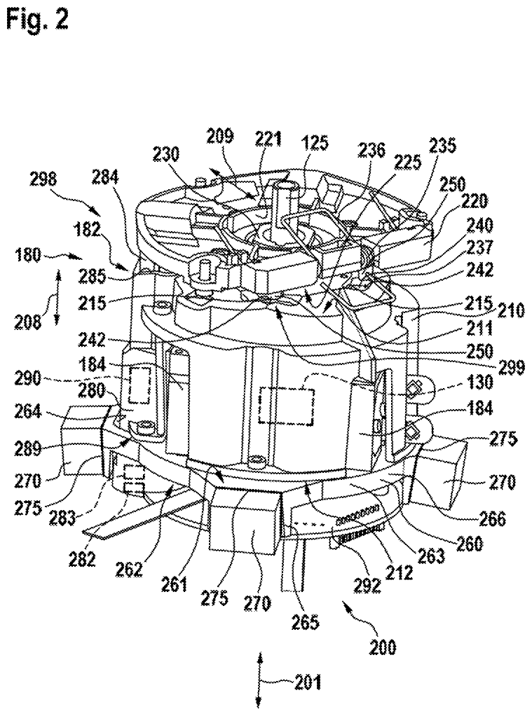

FIG. 2 shows the spindle 125 of the rotating laser 100 of FIG. 1 with the laser unit 130 and the leveling unit 180. The spindle 125 is mounted in a base plate 220 via a ball joint 230. Preferably, the base plate 220 is housing-fixed, that is to say, fixed immovably on the housing 110 of the rotating laser 100 of FIG. 1. Alternatively, the base plate 220 is formed in one piece with the housing 110 of the rotating laser 100 of FIG. 1. Preferably, the base plate 220 comprises a central recess 221 in which, at least in sections, the ball joint 230 is arranged.

On a lower side 225 of the base plate 220, a carrier plate 260 is, for example, arranged. The carrier plate 260 is preferably arranged at a predefined distance from the base plate 220. The carrier plate 260 preferably comprises a disk-shaped base body 266. Furthermore, the carrier plate 260 comprises an upper side 261 facing the base plate 220 and an underside 262 facing away from the base plate 220. On the carrier plate 260, preferably the leveling unit 180, the laser unit 130, and/or a control board 292 assigned to the electronics unit 190 of FIG. 1 is arranged.

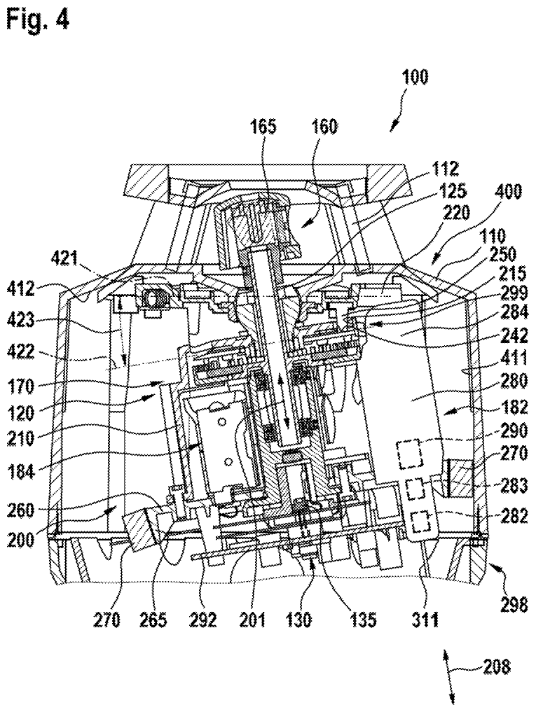

The at least one inclination adjustment unit 182 assigned to the leveling unit 180 is preferably configured for setting an inclination angle (423 in FIG. 4) of the carrier plate 260 relative to the housing-fixed base plate 220. The at least one inclination adjustment unit 182 is arranged, at least in sections, in a recess 264 of the carrier plate 260. Furthermore, the at least one inclination adjustment unit 182 is fixed to the carrier plate 260 by a screw connection 289, in particular, on the upper side 261 of the carrier plate 260 facing the base plate 220.

Preferably, a protective element 290 for protection in the event of an overload is assigned to the at least one inclination adjustment unit 182. In the context of the present disclosure, an overload event comprises at least one unintended tipping over and/or falling of the rotating laser (100) onto an underlying surface, in which the carrier plate (260) pivots in an uncontrolled manner.

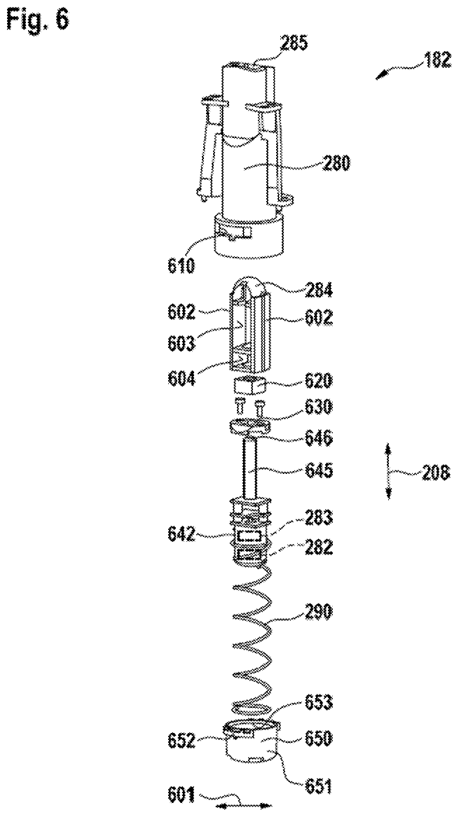

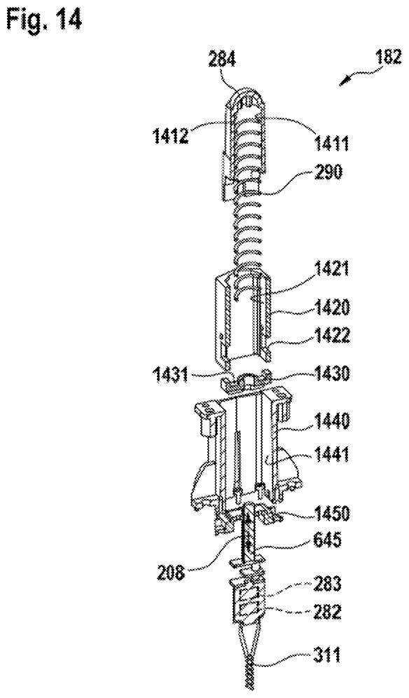

The at least one inclination adjustment unit 182 preferably comprises an inclination adjustment unit housing 280 (and 1440 in FIG. 14). In the inclination adjustment unit housing 280, preferably at least one motor 282 having a drive spindle (645 in FIG. 6) for displacing a plunger 284 along a longitudinal extent 208 of the drive spindle (645 in FIG. 6), or along a longitudinal extent 201 of the spindle 125, is arranged. Preferably, the motor 282 is a direct-current motor. The plunger 284 preferably bears against the housing-fixed base plate 220. Preferably, a predefined inclination angle (423 in FIG. 4) of the carrier plate 260 relative to the housing-fixed base plate 220 is adjustable by displacing the plunger 284 along the longitudinal extent 208. Here, the plunger 284 is preferably arranged displaceably in an interior receptacle 285 of the inclination adjustment unit housing 280. Alternatively or optionally, a gear mechanism 283 is assigned to the inclination adjustment unit 182.

Preferably, the protective element 290 is arranged within the inclination adjustment unit housing 280 (and 1440 in FIG. 14) of the inclination adjustment unit 182. Preferably, the protective element 290 is configured to be a spring element. The protective element 290 is preferably arranged on the drive side and/or on the output side on the motor 282.

Preferably, the carrier plate 260 comprises a laser assembly 200. The laser assembly 200 preferably comprises at least the laser unit 130, the drive unit 120 of the rotating laser 100 of FIG. 1, the leveling unit 180, and/or a control board 292 assigned to the electronics unit 190 of FIG. 1. The laser assembly 200 is arranged, at least in sections, on the carrier plate 260. Furthermore, the carrier plate 260 optionally comprises a housing 210. By way of example, the housing 210 is arranged with its underside 212 facing the carrier plate 260 on the upper side 261 of the carrier plate 260 facing the base plate 220. Preferably, the housing 210 is fastened to the carrier plate 260 by a screw connection. In the housing 210, at least the at least one inclination sensor 184 of the leveling unit 180 and/or the drive unit 120 are arranged.

Preferably, a biasing element 235 is provided, which is preferably arranged opposite the at least one inclination adjustment unit 182. The biasing element 235 is preferably configured to bias the carrier plate 260 back into an initial position after a displacement of the plunger 284. Preferably, the biasing element 235 is configured as a spring element, in particular, as a double-leg spring having a first and a second leg 236, 237. The second leg 237 is arranged on the upper side 211 of the housing 210 assigned to the carrier plate 260.

Preferably, an end-stop unit 299 having at least one contact element 250 is provided. The end-stop unit 299 is preferably configured to deactivate the inclination adjustment unit 182 upon reaching a maximum possible inclination angle (423 in FIG. 4). Preferably, the at least one contact element 250 is electrically conductive. Preferably, the at least one contact element 250 is elastically deformable in the event of an overload for protecting a laser assembly 200. Preferably, the at least one contact element 250 is both deformable and at least in sections electrically conductive. Preferably, the at least one contact element 250 is arranged on the housing-fixed base plate 220 by way of an injection compression molding process or an injection molding process. Alternatively, the at least one contact element 250 may be adhesively bonded to the base plate 220.

Preferably, the laser unit 130, the spindle 125, the at least one inclination sensor 184, and/or the at least one inclination adjustment unit 182 are arranged, at least in sections, in the housing 210. The housing 210 comprises, on its upper side 211 facing the base plate 220, a recess 215 assigned to the at least one contact element 250. The at least one recess 215 is, for example, configured to partially penetrate and contact a contact surface 242 assigned to a control board 240. Preferably, at least one, that is to say, the contact surface 242, is provided, wherein the contact surface 242 may be configured in an annular shape. Alternatively, a plurality of contact surfaces may be provided, which may be configured to be ring segments. Alternatively, a plurality of contact surfaces are assigned to one contact element 250, and/or a plurality of contact elements 250 are assigned to one contact surface.

By contacting the contact surface 242 of the control board 240 by way of the contact element 250, the motor 282 of the inclination adjustment unit 182 is preferably deactivatable. Preferably, the contact surface 242 and the inclination adjustment unit 182 are arranged spaced apart from one another in the radial direction 209 of the spindle 125. Alternatively or optionally, the motor 282 of the at least one inclination adjustment unit 182 is configured such that, upon reaching a maximum possible inclination angle (423 in FIG. 4), a direction of rotation of the motor 282 for reducing the inclination angle (423 in FIG. 4) is changeable.

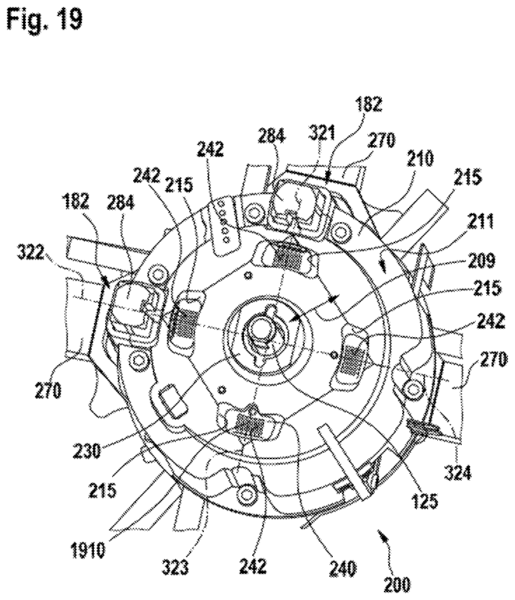

The control board 240 is assigned to the electronics unit 190 of FIG. 1. In particular, the control board 240 is, for example, assigned to the drive unit 120 of FIG. 1. Preferably, the control board 240 is arranged on an upper side 261 of the carrier plate 260 facing away from the base plate 220, illustratively facing the base plate 220. Preferably, the contact surface 242 is configured to be a meander contact (1910 in FIG. 19).

Preferably, an overload protection device 298 for protecting the laser assembly 200 in the event of an overload is provided. Preferably, at an outer circumference 263 of the carrier plate 260, at least one damping protective element 270 is arranged, which is assigned to the overload protection device 298. The at least one damping protective element 270 is preferably arranged, at least in sections, at the outer circumference 263 of the carrier plate 260. Here, the at least one damping protective element 270 is configured to be an extension of the carrier plate 260 in the radial direction 209. Alternatively, a damping protective element 270 is arranged along the entire outer circumference 263 of the carrier plate 260. The at least one damping protective element 270 preferably comprises damping foam.

Preferably, the carrier plate 260 comprises, at its outer circumference, at least one fastening section 265, which extends the carrier plate 260 along the longitudinal extent of the spindle 125. The carrier plate 260 is extended in the direction of the control board 292. Preferably, the at least one damping protective element 270 is arranged, in particular, fastened, on the fastening section 265.

Three damping protective elements 270 are arranged at the outer circumference 263 of the carrier plate 260. The three damping protective elements 270 are configured in a cuboid shape. It is pointed out that the three damping protective elements 270 may also each have any other shape, for example, that of an ellipsoid.

Preferably, an adhesive 275 is assigned to the at least one damping protective element 270 for forming an adhesive bond with the carrier plate 260 and/or the housing 110. Alternatively or optionally, the protective element 290 is assigned to the overload protection device 298. Furthermore, alternatively or optionally, the contact element 250 is assigned to the overload protection device 298.

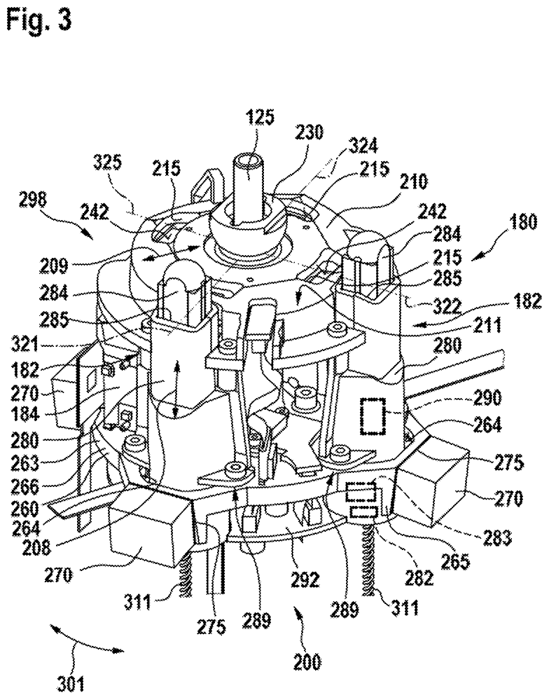

FIG. 3 shows the carrier plate 260 having the laser assembly 200 and the housing 210 of FIG. 2, which are arranged in a rotated position along a circumferential direction 301 of the carrier plate 260 compared to FIG. 2. FIG. 2 illustrates two inclination adjustment units 182 assigned to the laser assembly 200. Preferably, the two inclination adjustment units 182 are configured to be at least substantially identical. Here, each inclination adjustment unit 182 is assigned to a power cable 311.

Furthermore, four contact surfaces 242 are, for example, provided in FIG. 3. Here, preferably, in each case two contact surfaces 242 are arranged on a common radial axis 321, 322. Preferably, one inclination adjustment unit 182 is also arranged on each radial axis 321, 322. Here, the respective contact surface 242 and the inclination adjustment unit 182 are preferably arranged spaced apart from one another in the radial direction 209. In particular, the respective contact surface 242 is arranged, in the radial direction 209, between the spindle 125 and the inclination adjustment unit 182. Preferably, the two radial axes 321, 322 are arranged adjacent to one another. The two axes 321, 322 are arranged at a distance of 90°from one another. Preferably, a radial axis 324 is arranged diametrically opposite the radial axis 321, and/or a radial axis 325 is arranged diametrically opposite the radial axis 322. Preferably, a contact surface 242 is assigned to each of the radial axes 324, 325.

FIG. 4 shows the rotating laser 100 of FIG. 1 having the housing 110, which comprises an interior receptacle 412, in which the base plate 220 and the carrier plate 260 having the laser unit 200 are arranged. FIG. 4 illustrates an end-stop position 400 of the laser assembly 200. By displacing the plunger 284 of the inclination adjustment unit 182 along the longitudinal extent 208 of the drive spindle (645 in FIG. 6), or along a longitudinal extent 201 of the spindle 125, a predefined inclination angle 423 of the carrier plate 260 relative to the housing-fixed base plate 220 is settable. The inclination angle 423 is formed or set between an axis 421 assigned to the base plate 220 and an axis 422 assigned to the carrier plate 260.

Alternatively or optionally, the at least one damping protective element 270 of FIG. 2 is arranged on an inner circumference 411 of the housing 110 of the rotating laser 100 assigned to the interior receptacle 412. Here, the damping protective element 270 is, for example, configured in the circumferential direction completely on the inner circumference 411 or at least in sections on the inner circumference 411. The damping protective element 270 is, as described above, assigned to the overload protection device 298 of FIG. 2. In the end-stop position 400 shown in FIG. 4, the damping protective element 270 arranged on the carrier plate 260 preferably rests against the inner circumference 411 of the housing 110, and/or the damping protective element 270 arranged on the inner circumference 411 of the housing 110 rests against the outer circumference 263 of the carrier plate 260.

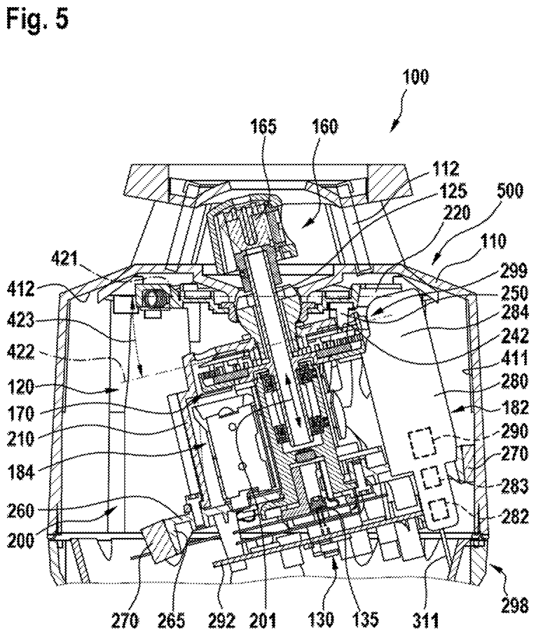

FIG. 5 shows the rotating laser 100 of FIG. 1 having the base plate 220, as well as the carrier plate 260 having the laser unit 200 of FIG. 4, and illustrates an overload position 500 of the laser assembly 200, in which the rotating laser 100, for example, falls onto its right side. Here, the right damping protective element 270 arranged on the carrier plate 260 is compressed, whereby contact of the carrier plate 260 with the housing 110 is prevented and thus destruction and/or damage of the laser assembly 200 may be prevented. In particular, destruction of the control board 292, the inclination adjustment unit 182, the drive unit 120, and/or the laser unit 130 is prevented.

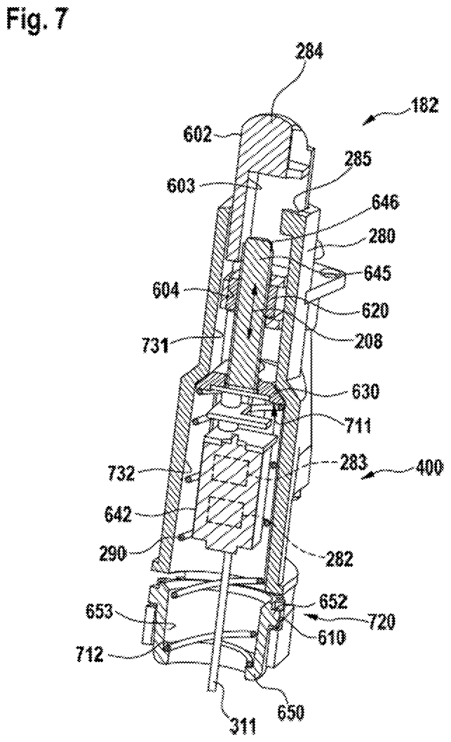

FIG. 6 shows the inclination adjustment unit 182 of FIG. 1 to FIG. 5 having the inclination adjustment unit housing 280, the plunger 284, the motor 282, the gear unit 283, and the protective element 290. Preferably, the gear unit 283 is a spur gear unit. As described above, the inclination adjustment unit housing 280 comprises an interior receptacle 285, in which the plunger 284 is arranged to be displaceable. At a lower region, the inclination adjustment unit housing 280 comprises a recess 610. A cap 650 is assigned to the lower region, which closes the inclination adjustment unit housing 280 at the bottom. The cap 650 comprises an interior receptacle 653 and an outer circumference 651, on which at least one extension part 652 is arranged. The extension part 652 extends the cap 650, by way of example, in a radial direction 601. Preferably, the cap 650, in particular, the extension part 652, together with the recess 610 of the inclination adjustment unit housing 280 forms a bayonet connection (720 in FIG. 7).

Furthermore, FIG. 6 illustrates a drive spindle 645 of the motor 282 of the inclination adjustment unit 182. Preferably, the drive spindle 645 comprises, in sections, an external thread. Preferably, the external thread of the drive spindle 645 is a fine pitch thread. At its end facing away from the motor 282, the drive spindle 645, for example, comprises a step 646.

The plunger 284 preferably comprises a first, upper receptacle 603 and a second, lower receptacle 604. Furthermore, the plunger 284 preferably comprises two lateral guide surfaces 602.

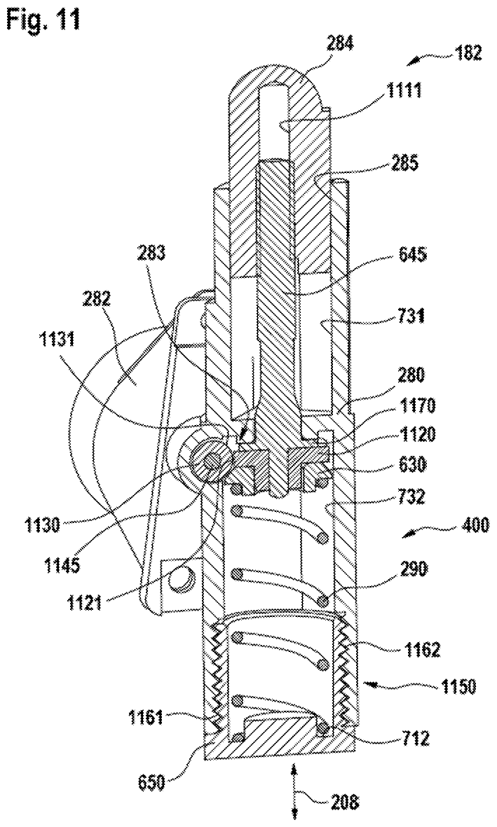

Preferably, the plunger 284 is operatively connected to the drive spindle 645 by way of a screw connection. Preferably, the plunger 284 is assigned to a threaded insert 620 (and 1430 in FIG. 14) or an internal thread (1111 in FIG. 11). In the event of an overload, the drive spindle 645 is preferably separated from the threaded insert 620 or the internal thread (1111 in FIG. 11). Here, the step 646 decouples the drive spindle 645 from the threaded insert 620 or the internal thread (1111 in FIG. 11) in the event of an overload. Preferably, the step 645 has no thread. Preferably, when the drive spindle 645 leaves the threaded insert 620, the step 646 of the drive spindle 645 serves to allow the drive spindle 645 to be screwed back into the threaded insert 620 upon reverse rotation.

Preferably, the threaded insert 620 is assigned to the lower receptacle 604. Preferably, the threaded insert 620 comprises a cuboid base body. Furthermore, a guide part 630 for guiding in the inclination adjustment unit housing 280 is, for example, assigned to the drive spindle 645. The guide part 630 preferably supports the motor 282.

Preferably, the protective element 290 configured to be a spring element is arranged coaxially with respect to the drive spindle 645. Preferably, the protective element 290 is aligned coaxially with the longitudinal extent 208 of the drive spindle 645, or aligned in the longitudinal direction of the drive spindle 645. The protective element 290 is arranged on an outer circumference 642 of the motor 282. Preferably, the motor 282 is arranged along a longitudinal extent 208 of the drive spindle 645.

FIG. 7 shows the inclination adjustment unit 182 of FIG. 6 in the end-stop position 400 of FIG. 4. The threaded insert 620 is arranged in the receptacle 604 of the inclination adjustment unit housing 280. The drive spindle 645 is preferably operatively connected to the threaded insert 620 via its thread, such that a rotation of the drive spindle 645 displaces the plunger in the longitudinal direction 208 of the drive spindle 645 in the interior receptacle 285 of the inclination adjustment unit housing 280. The interior receptacle 285 preferably comprises an upper interior space 731, which widens into a lower interior space 732. The plunger 284 is, for example, arranged at least in sections in the upper interior space 731.

According to FIG. 7, the protective element 290 is preferably arranged in the lower interior space 732 of the inclination adjustment unit housing 280 of the inclination adjustment unit 182 assigned to the motor 282. The guide part 630 is preferably likewise arranged in the lower interior space 732. Furthermore, the protective element 290 is, for example, arranged between an underside 711 of the guide part 630 facing the motor 282 and a stop edge 712 facing the interior receptacle 653 of the cap 650.

Furthermore, FIG. 7 illustrates an exemplary bayonet connection 720 of the cap 650 with the inclination adjustment unit housing 280. Preferably, the extension part 652 of the cap 650 forms the bayonet connection 720 together with the recess 610 of the inclination adjustment unit housing 280.

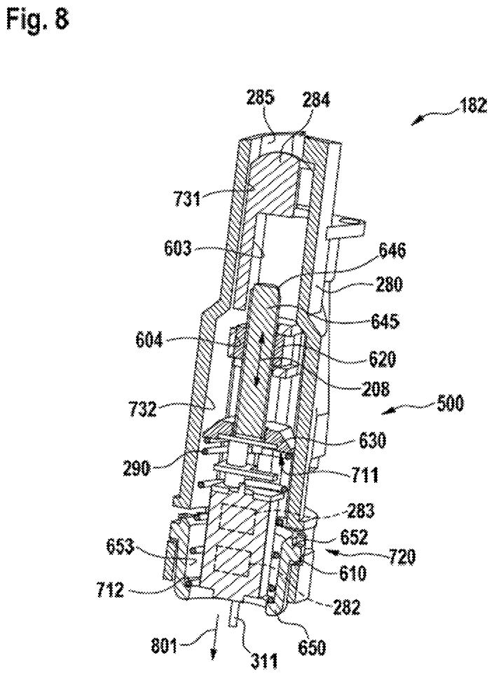

FIG. 8 shows the inclination adjustment unit 182 of FIG. 7 in the overload position 500 of FIG. 5, wherein, according to FIG. 8, the overload event is triggered, by way of example, by a fall of the rotating laser 100 of FIG. 1 onto an underlying surface. Here, the laser assembly 200 swings to the right and the plunger 284 yields downward. The entire assembly consisting of the motor 282, the drive spindle 645, the threaded insert 620, the guide part 630, and the plunger 284 is displaced downward or along an arrow 801. The plunger 284 is preferably displaced into the interior receptacle 285 of the inclination adjustment unit housing 280, that is, into the upper interior space 731. The protective element 290 is compressed in the process. The biasing element 235 of FIG. 2, that is to say the double-leg spring, must have a lower spring rate than the protective element 290 such that, after an overload event, the laser assembly 200 is returned to the normal or operating state.

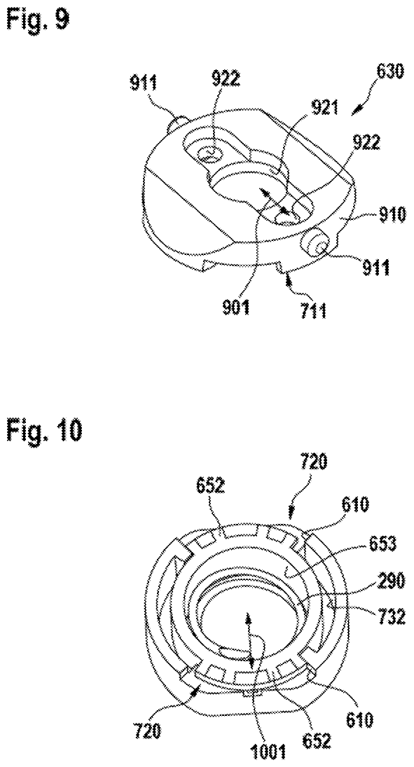

FIG. 9 shows the guide part 630 of the inclination adjustment unit 182 of FIG. 6 to FIG. 8. Preferably, the guide part 630 comprises a disk-shaped base body having an outer circumference 910. The guide part 630 preferably comprises, at its outer circumference 910, at least one, two lateral radial extensions 911. The radial extensions 911 extend the guide part 630 in a radial direction 901. The radial extensions 911 are preferably configured to guide the guide part 630 in corresponding grooves of the inclination adjustment unit housing 280 in the event of an overload and thus to prevent rotation of the motor 282.

For supporting the drive spindle 645, the guide part 630 preferably comprises a central recess 921. Furthermore, the guide part 630 preferably comprises at least one, two recesses 922 arranged laterally with respect to the recess 921 for connection to the motor 282. Preferably, the motor 282 is connected to the guide part 630 by a screw connection. Alternatively, the guide part 630 may also be formed in one piece with the motor 282.

FIG. 10 shows the bayonet connection 720 of FIG. 7 of the cap 650 with the inclination adjustment unit housing 280 of FIG. 2. Preferably, the extension part 652 of the cap 650 forms the bayonet connection 720 together with the recess 610 of the inclination adjustment unit housing 280. As mentioned above, the extension part 652 is configured to be an extension in the radial direction 1001.

FIG. 11 shows the inclination adjustment unit 182 of FIG. 1, which is configured according to an alternative embodiment. Here, the motor 282 of FIG. 2 is preferably arranged transversely, in particular, perpendicularly, to the longitudinal extent 208 of the drive spindle 645 of FIG. 6. A gear wheel 1120 is preferably assigned to the drive spindle 645. The gear wheel 1120 is arranged along the longitudinal extent 208 of the drive spindle 645 between the guide part 630 and a circumferential collar 1170 of the drive spindle 645. Preferably, an intermediate shaft 1145 having a gear 1130 is assigned to the motor 282. In a normal operation 400 of the motor 282, as shown in FIG. 11, the gear 1120 of the drive spindle 645 is preferably operatively connected to the gear 1130 of the motor 282. For this purpose, the gear 1130 comprises external toothing 1131 and the gear 1120 comprises external toothing 1121.

Furthermore, the plunger 284 preferably comprises an internal thread 1111 for connection to the drive spindle 645. Furthermore, the cap 650 comprises, by way of example, an external thread 1161, and the inclination adjustment unit housing 280 preferably comprises an internal thread 1162 for forming a screw connection 1150. Alternatively, the inclination adjustment unit housing 280 comprises an external thread, and the cap 650 comprises an internal thread for forming a screw connection 1150.

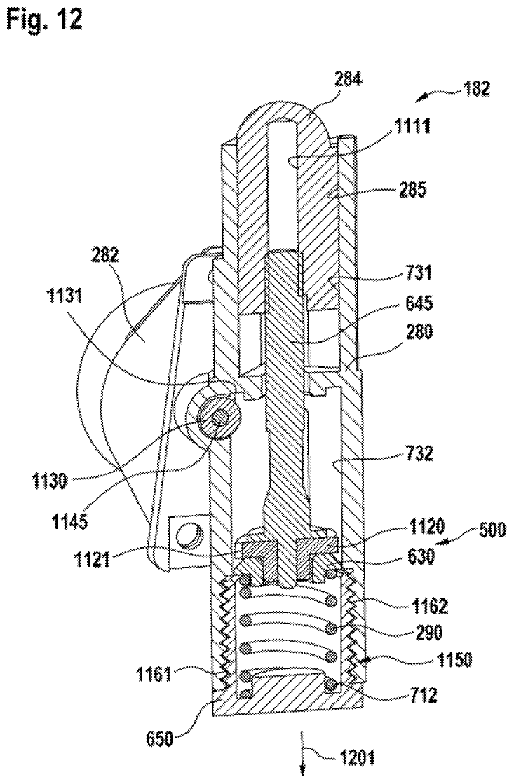

FIG. 12 shows the inclination adjustment unit 182 of FIG. 11 in the event of a malfunction of the motor 282, or in the overload position 500 of FIG. 5. The protective element 290 of FIG. 2 is compressed, and the gear 1120 of the drive spindle 645 is thus separated from the gear 1130 of the motor 282, whereby a transmission of a rotational movement of the motor 282 to the drive spindle 645 is interrupted. Here, the plunger 284, the thread between the plunger 284 and the drive spindle 645, as well as the drive spindle 645 are likewise protected. In the event of an impact from above on the plunger 284, as shown in FIG. 5, the plunger 284 and the drive spindle 645 may yield downward along a direction of an arrow 1201 against the protective element 290.

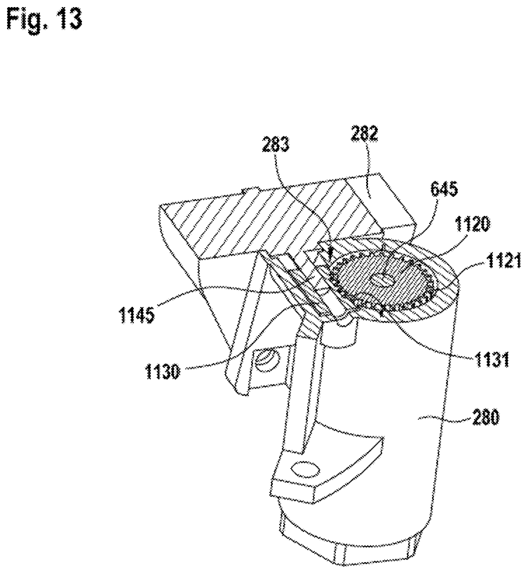

FIG. 13 shows the gear unit 283 of the inclination adjustment unit 182 of FIG. 11 and FIG. 12. FIG. 13 illustrates the gear 1120 assigned to the drive spindle 645, the gear 1130 assigned to the motor 282, as well as the intermediate shaft 1145.

FIG. 14 shows the inclination adjustment unit 182 of FIG. 1, which is configured according to a further embodiment. Here, the protective element 290 is preferably arranged at least in sections in an interior space 1411 of the plunger 284 of FIG. 2. The interior space 1411 is arranged facing the motor 282.

Furthermore, the plunger 284 is arranged movably, along the longitudinal extent 208 of the drive spindle 645, in an interior receptacle 1421 of a guide element 1420. The guide element 1420, in turn, is preferably arranged movably, along the longitudinal extent 208 of the drive spindle 645, in an interior receptacle 1441 of an inclination adjustment unit housing 1440 of the inclination adjustment unit 182. The drive spindle 645 preferably displaces the plunger 284 along the longitudinal extent 208 of the drive spindle 645 by way of a threaded insert 1430. Here, the threaded insert 1430 is preferably operatively connected to the guide element 1420. Preferably, the guide element 1420 comprises, for this purpose, at least one recess 1422.

The protective element 290 is preferably arranged in the interior space 1411 of the plunger 284 coaxially relative to the drive spindle 645. Furthermore, the protective element 290 is preferably arranged along the longitudinal extent 208 of the drive spindle 645 between a stop edge 1412 of the interior space 1411 of the plunger 284 facing the motor 282 and a bottom surface 1431 of the threaded insert 1430.

Furthermore, a cover 1450 is, for example, provided, which is configured to close the inclination adjustment unit housing 1440 of the inclination adjustment unit 182 at an end opposite the plunger 284. According to FIG. 14, the motor 282 is arranged outside the inclination adjustment unit housing 1440 of the inclination adjustment unit 182. In FIG. 14, the motor 282 is arranged below the inclination adjustment unit housing 1440.

The protective element 290 may alternatively or optionally be arranged in the region between the threaded insert 1430 and the cover 1450.

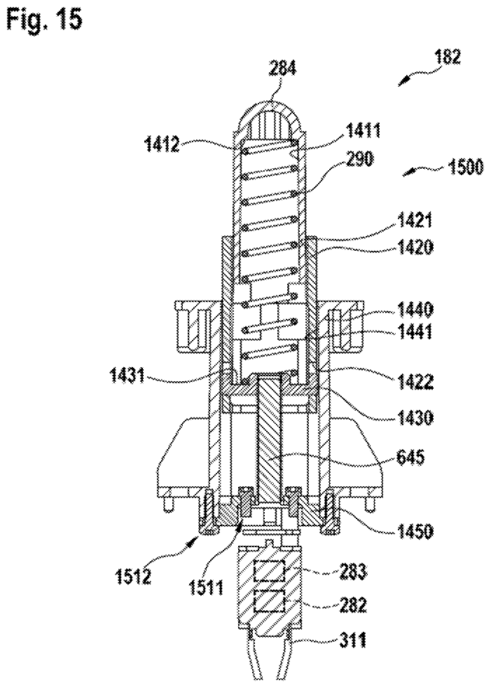

FIG. 15 shows the inclination adjustment unit 182 of FIG. 14 in an extended position 1500. The guide element 1420 is arranged at least in sections outside the interior receptacle 1441 of the inclination adjustment unit housing 1440, and the plunger 284 is arranged at least in sections outside the interior receptacle 1421 of the guide element 1420.

Furthermore, FIG. 15 shows an exemplary screw connection 1511 between the cover 1450 and the motor 282. Furthermore, FIG. 15 shows an exemplary screw connection 1512 between the cover 1450 and the inclination adjustment unit housing 1440.

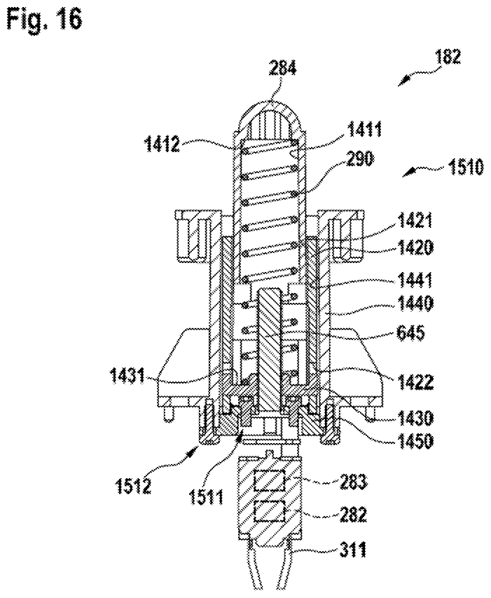

FIG. 16 shows the inclination adjustment unit 182 of FIG. 15 in a retracted position 1510. The guide element 1420 is arranged completely within the interior receptacle 1441 of the inclination adjustment unit housing 1440, and the plunger 284 is arranged at least in sections outside the interior receptacle 1421 of the guide element 1420.

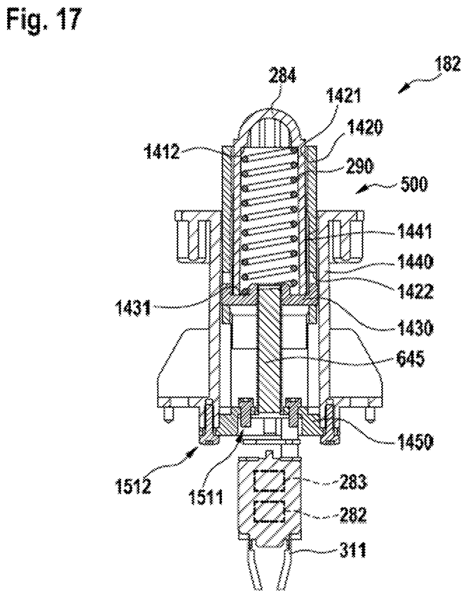

FIG. 17 shows the inclination adjustment unit 182 of FIG. 15 and FIG. 16 in the overload position 500 according to FIG. 5. The guide element 1420 is arranged in sections outside the interior receptacle 1441 of the inclination adjustment unit housing 1440, and the plunger 284 is arranged as far as possible in the interior receptacle 1421 of the guide element 1420. Here, the protective element 290 is completely compressed.

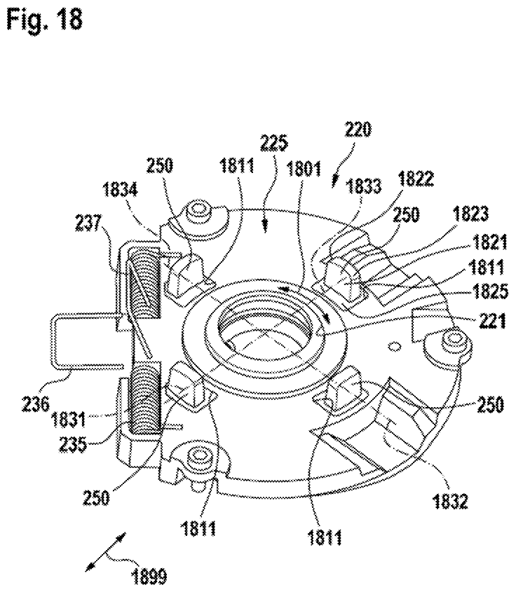

FIG. 18 shows the base plate 220 of FIG. 2 as viewed from its side 225. Preferably, the at least one contact element 250 is arranged in an assigned recess 1811 of the housing-fixed base plate 220. Preferably, the at least one contact element 250 forms a material-bonded connection with the recess 1811, for example, an adhesive bond. Alternatively, the at least one contact element 250 is fixed in the recess 1811 by way of an injection pressing process or an injection molding process. Preferably, the at least one contact element 250 is aligned along main axes 1831, 1832, 1833, 1834 assigned to the housing-fixed base plate 250. Preferably, the main axes 1831, 1832, 1833, 1834 are aligned along a radial direction 1899 of the base plate 1899.

Preferably, the at least one contact element 250 comprises a cuboid base body 1821 having rounded corners 1822, 1823. Preferably, the cuboid base body 1821 is arranged on a base section 1825. The base section 1825 is preferably arranged in the recess 1811, wherein the cuboid base body 1821 is arranged perpendicularly on the base section 1825. Furthermore, the at least one contact element 250 is curved in the circumferential direction 1801 of the base plate. Alternatively, the base body 1821 may also have any other shape, for example, cylindrical.

FIG. 19 shows the carrier plate 260 with the laser assembly 200 and the housing 210 of FIG. 3 and illustrates the exemplary four recesses 215 with the contact surfaces 242 arranged on the upper side 211. Preferably, a contact surface 242 is assigned to each recess 215. Preferably, the contact surface 242 is configured to be a meander contact 1910. The contact surface 242 comprises a meander contact 1910. Alternatively, a contact surface 242 may also comprise a plurality of meander contacts 1910.

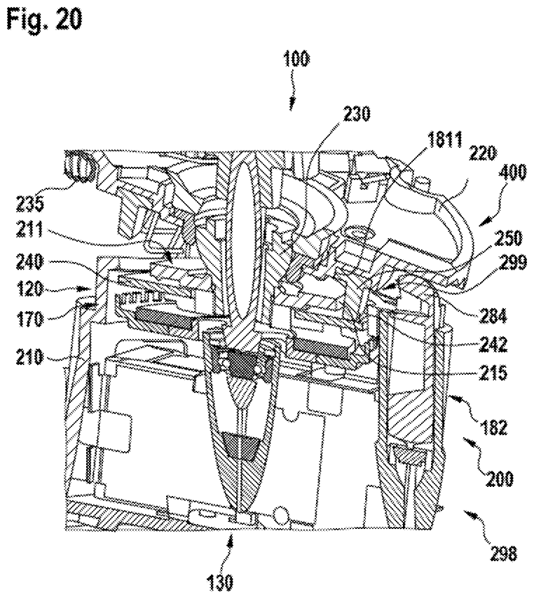

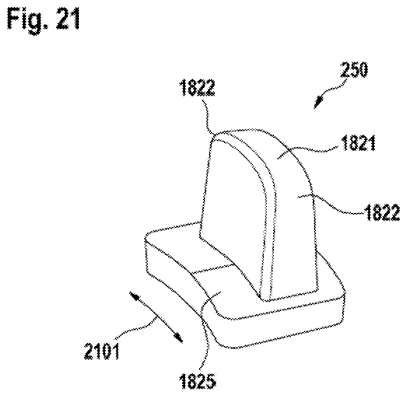

FIG. 20 shows the rotating laser 100 of FIG. 1 and FIG. 4 and illustrates contact of the right contact element 250 of the base plate 220 with the right contact surface 242 of the control board 240 of the carrier plate 260. FIG. 20 thereby shows, by way of example, a protrusion of the right contact element 250 through the recess 215 of the upper side 211 of the housing (210).

FIG. 21 shows the contact element 250 of the base plate 220 of FIG. 2, FIG. 4, FIG. 18, and FIG. 20 with the base section 1825 and the cuboid base body 1821 having the rounded corners 1822, 1823. Preferably, the contact element 250 is configured to be curved along its longitudinal extent 2101.

What is claimed is:

1. A rotating laser, comprising:
a housing;
a carrier plate;
a housing-fixed base plate arranged in the housing and spaced apart from the carrier plate by a predefined distance;
a laser assembly assigned to the carrier plate; and
an overload protection device configured to protect the laser assembly in the event of an overload.

2. The rotating laser according to claim 1, wherein:
the laser assembly includes a laser unit configured to generate laser beam, a drive unit configured to rotate the laser beam, and a leveling unit configured to set an inclination angle of the carrier plate relative to the housing-fixed base plate, and
the leveling unit includes at least one inclination sensor and at least one inclination adjustment unit and/or includes a control board assigned to an electronics unit.

3. The rotating laser according to claim 1, wherein the laser assembly is arranged on the carrier plate.

4. The rotating laser according to claim 2, wherein an additional housing is assigned to the carrier plate, in which at least the at least one inclination sensor of the leveling unit and/or the drive unit is arranged.

5. The rotating laser according to claim 1, wherein at least one damping protective element is arranged on an outer circumference of the carrier plate, which is assigned to the overload protection device.

6. The rotating laser according to claim 5, wherein the at least one damping protective element includes damping foam.

7. The rotating laser according to claim 1, wherein at least one damping protective element is arranged on an inner circumference of the housing, which is assigned to the overload protection device.

8. The rotating laser according to claim 5, wherein an adhesive for forming an adhesive bond with the carrier plate and/or the housing is assigned to the at least one damping protective element.

9. The rotating laser according to claim 2, wherein the overload protection device includes a protective element assigned to the at least one inclination adjustment unit.

10. The rotating laser according to claim 9, wherein:
the inclination adjustment unit has an inclination adjustment unit housing in which at least one motor with a drive spindle for displacing a plunger along a longitudinal extent of the drive spindle is arranged,
the plunger is positioned in contact with the housing-fixed base plate,
a displacement of the plunger along the longitudinal extent sets a predefined angle of inclination of the carrier plate relative to the housing-fixed base plate, and
the protective element is designed as a spring element arranged inside the inclination adjustment unit housing.

11. The rotating laser according to claim 10, wherein the protective element is arranged in an interior space of the plunger coaxially with the drive spindle.

12. The rotating laser according to claim 10, wherein the protective element is arranged on the drive side and/or on the output side of the motor.

13. The rotating laser according to claim 1, further comprising an end-stop unit having at least one contact element, which is configured to deactivate the inclination adjustment unit upon reaching a maximally possible inclination angle, wherein:
the at least one contact element is electrically conductive, and
the at least one contact element is assigned to the overload protection device.

14. The rotating laser according to claim 13, wherein the at least one contact element is elastically deformable in the event of an overload for protecting the laser assembly.

15. The rotating laser according to claim 14, wherein the at least one contact element, upon reaching a maximally possible inclination angle, contacts a contact surface arranged on the housing-fixed base plate and assigned to a control board, and thereby deactivates the motor assigned to the inclination adjustment unit.
